(19) United States
(12) Patent Application Publication
(10) Pub. No.: US 2006/0278597 A1
(43) Pub. Date: Dec. 14, 2006

(54) INFANT FEEDING BOTTLE WITH FORMULA MONITOR SYSTEM

(75) Inventors: Jonathan Daugherty, Clayton, OH (US); Andrew Mendenhall, Mooresville, IN (US); Paul T. Zink, Indianapolis, IN (US); Michael C. Dorsey, Irvine, CA (US); Dennis M. Turner, Mooresville, IN (US)

Correspondence Address: BARNES & THORNBURG LLP, 11 SOUTH MERIDIAN, INDIANAPOLIS, IN, 46204, US

(73) Assignee: CATALYST PDG, INC., Indianapolis, IN (US)

(21) Appl. No.: 11/275,585

(22) Filed: Jan. 17, 2006

Related U.S. Application Data
(60) Provisional application No. 60/645,176, filed on Jan. 19, 2005.

(51) Int. Cl. A61J 11/00; A61J 9/04; B65D 51/16; G01F 19/00; B65D 23/10

(52) U.S. Cl. 215/11.1; 215/307; 215/11.5; 215/396; 73/427

(57) ABSTRACT

A liquid-dispensing bottle includes a container and a liquid dispenser closing an open mouth of the container. The container includes a “vertical” volume measurement scale arranged to provide a visual indication (to a caregiver) of the volume of liquid extant in the container when the container is not in use and is placed in an upright orientation on a countertop. In an illustrative embodiment, the bottle is used to dispense formula or other liquid to an infant.

This application claims priority under 35 U.S.C. § 119(e) to U.S. Provisional Application Ser. No. 60/645,176, filed Jan. 19, 2005, which is expressly incorporated by reference herein.

### BACKGROUND

The present disclosure relates to infant feeders, and particularly to bottles for dispensing liquids to infants. More particularly, the present disclosure relates to liquid measurement systems for liquids in baby bottles.

### SUMMARY

According to the present disclosure, a liquid-dispensing bottle comprises a container and a liquid dispenser closing an open mouth of the container. The container includes a “vertical” volume measurement scale arranged to provide a visual indication (to a caregiver) of the volume of liquid extant in the container when the container is not in use and is placed in an upright orientation on a countertop. In an illustrative embodiment, the bottle is used to dispense formula or other liquid to an infant.

The container also includes an “inclined” volume measurement scale arranged to provide a visual indication (to a caregiver) of the volume of liquid extant in the container when the bottle is held by a child or a caregiver (for the child) in a normal feeding position. This normal feeding position is established when (1) the bottle is retained in an inclined position to provide the liquid dispenser to an infant consuming liquid dispensed from the container and (2) the bottle is inclined at about a “predetermined angle” with respect to a horizontal reference plane. In the illustrated embodiment, the inclined volume measurement scale is provided along a line that lies in a plane and winds around a curved exterior surface of the container and the plane including that line is positioned to lie in about a vertical orientation when the bottle is inclined at about said predetermined angle. By using the inclined volume measurement scale, a caregiver can monitor the amount of formula being consumed by the infant during feeding without interrupting that feeding to place the bottle in an upright position on a table to determine the volume of formula left in the bottle using the vertical volume measurement scale.

In illustrative embodiments, the liquid-dispensing bottle further comprises a holder adapted to be gripped by an infant to retain the container at about the predetermined angle during feeding. The holder includes, for example, a mount ring configured to mate with the container at the open mouth and a pair of grip handles. Each grip handle is cantilevered to the mount ring and arranged to extend at an acute angle with respect to a “horizontal plane” established by the mount ring.

In other illustrative embodiments, the container has a tapered waistline and the liquid dispenser can take many forms. For example, the liquid dispenser could include either a lid, spout, nipple, or straw holder.

In other illustrative embodiments, the liquid-dispensing bottle further comprises a cap configured to mount on and cover exposed portions of the liquid dispenser. The cap includes, for example, a shell formed to include an interior region receiving portions of the liquid dispenser therein. The cap also includes a drip container coupled to the shell and arranged to lie in the interior region and mate with, for example, a nipple defined by the liquid dispenser while the shell is mounted on the liquid dispenser so that any liquid discharged from the nipple inadvertently is retained in the drip container while the cap is in place on the liquid dispenser.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a liquid-dispensing bottle in accordance with the present disclosure showing, on a narrow-waisted container, a “right-side up” vertical volume measurement scale for providing a visual indication (to a caregiver) of the volume of liquid extant in the container in the upright position shown in FIG. 1 and an “upside down” inclined volume measurement scale for providing a visual indication (to a caregiver) of the volume of liquid extant in the container during infant feeding as suggested in FIGS. 4 and 5 when the bottle is tilted by the caregiver to cause the inclined volume measurement scale to assume a vertical (or nearly vertical) orientation;

FIG. 2 is an exploded perspective assembly view of components that can be assembled to produce the liquid-dispensing bottle of FIG. 1 showing a container comprising an hour glass-shaped sleeve and a bottom closure including a valve and a valve base, a holder including a mount ring and a pair of grip handles coupled to the mount ring, a liquid dispenser including a nipple and a nipple mount, and a cap comprising a shell and a drip container depending from a ceiling of the shell, and also showing an alternative orientation of the holder (relative to the container) and three alternative configurations of the liquid dispenser;

FIG. 3 is a perspective view of a container in accordance with another embodiment of the present disclosure;

FIG. 4 is a side elevation view of the liquid-dispensing bottle of FIG. 1 in use and shown, on the inclined volume measurement scale, that the infant feeding from the bottle has consumed a little over one ounce of formula (and that six and three-quarter ounces of formula remain in the bottle);

FIG. 5 is a view similar to FIG. 4 but “taken” a short time later showing, again on the inclined volume measurement scale, that the infant feeding from the bottle has now consumed about three and one-half ounces of formula (and that four and one-half ounces of formula remain in the bottle);

FIG. 6 is an enlarged sectional view of the liquid-dispensing bottle of FIG. 1 taken along lines 6-6 of FIG. 1 showing formation of an offset wall in the narrow-waisted sleeve of the container to partition the narrow-waisted sleeve into upper and lower portions and to establish an inclined line along the inclined volume measurement scale and showing mating engagement of the drip container and the underlying nipple in an interior region of a shell included in the cap and configured to carry the drip container above the nipple;

FIG. 7 is a view of a portion of the bottle shown in FIG. 6 showing liquid extant in the nipple as it falls drop-by-drop into a liquid reservoir provided in the drip container;

FIG. 8 is a perspective view of the liquid-dispensing bottle of FIG. 1 showing an infant gripping the two grip handles included in the bottle holder;

FIG. 9 is an end elevation view of the bottle of FIG. 1 as it lies “lengthwise” on a flat surface and showing the orientation and use of the handle grips to limit “rolling” movement of the bottle on the flat surface; and

FIG. 10 is a view of a “rotation-blocking” feature in accordance with another embodiment of the disclosure.

### DETAILED DESCRIPTION

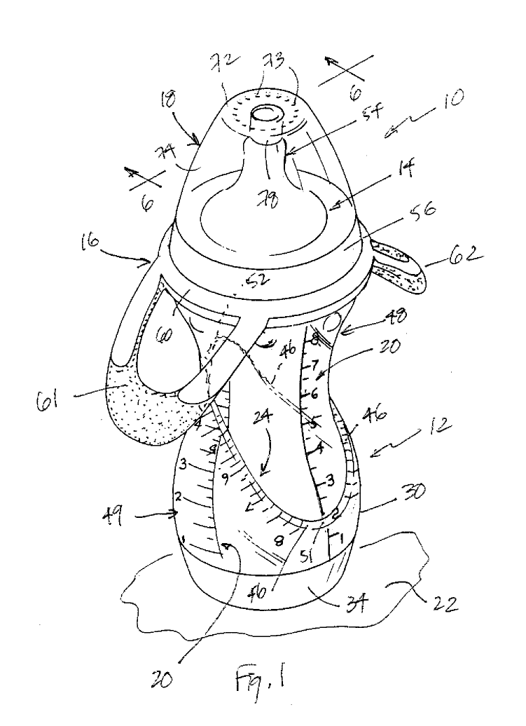

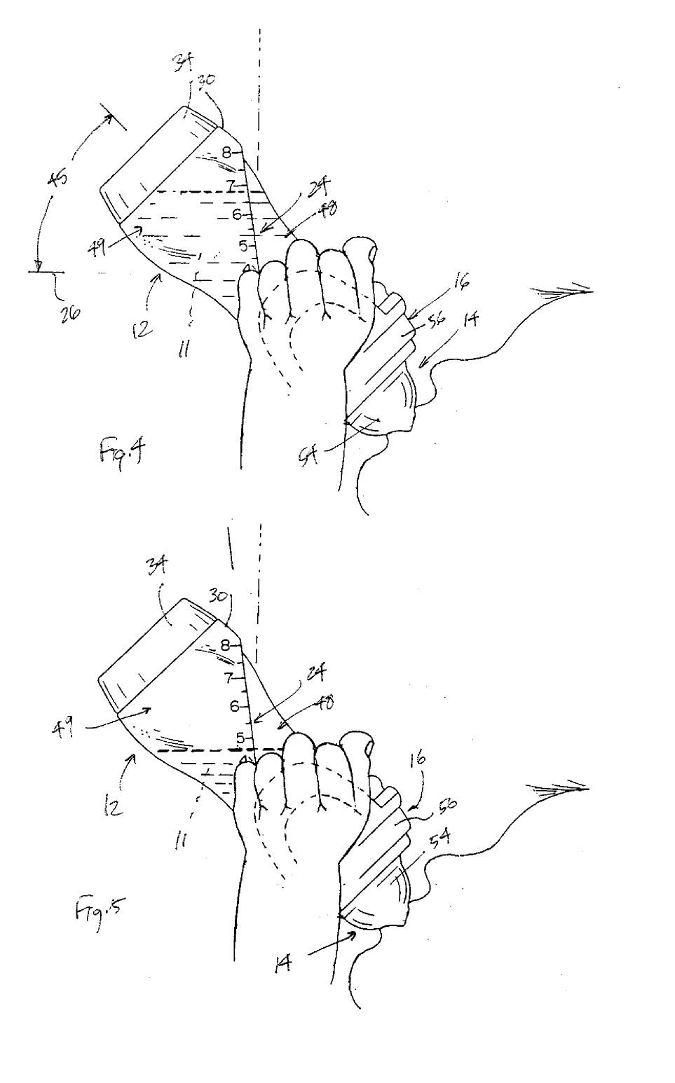

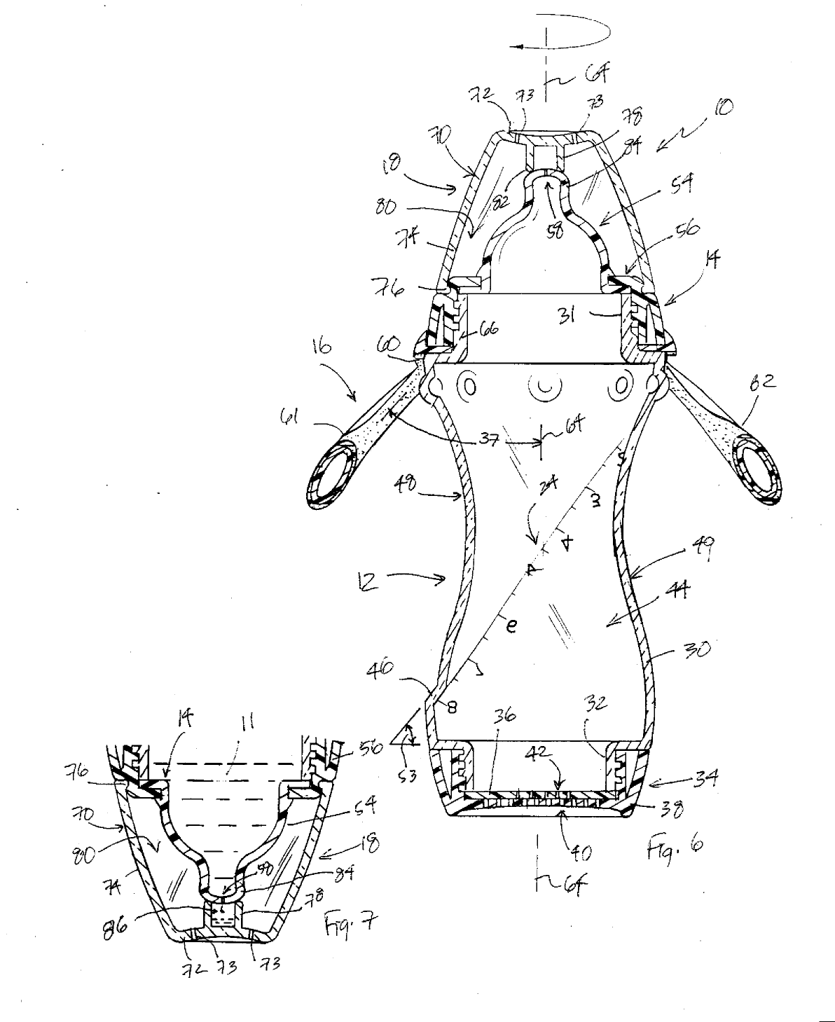

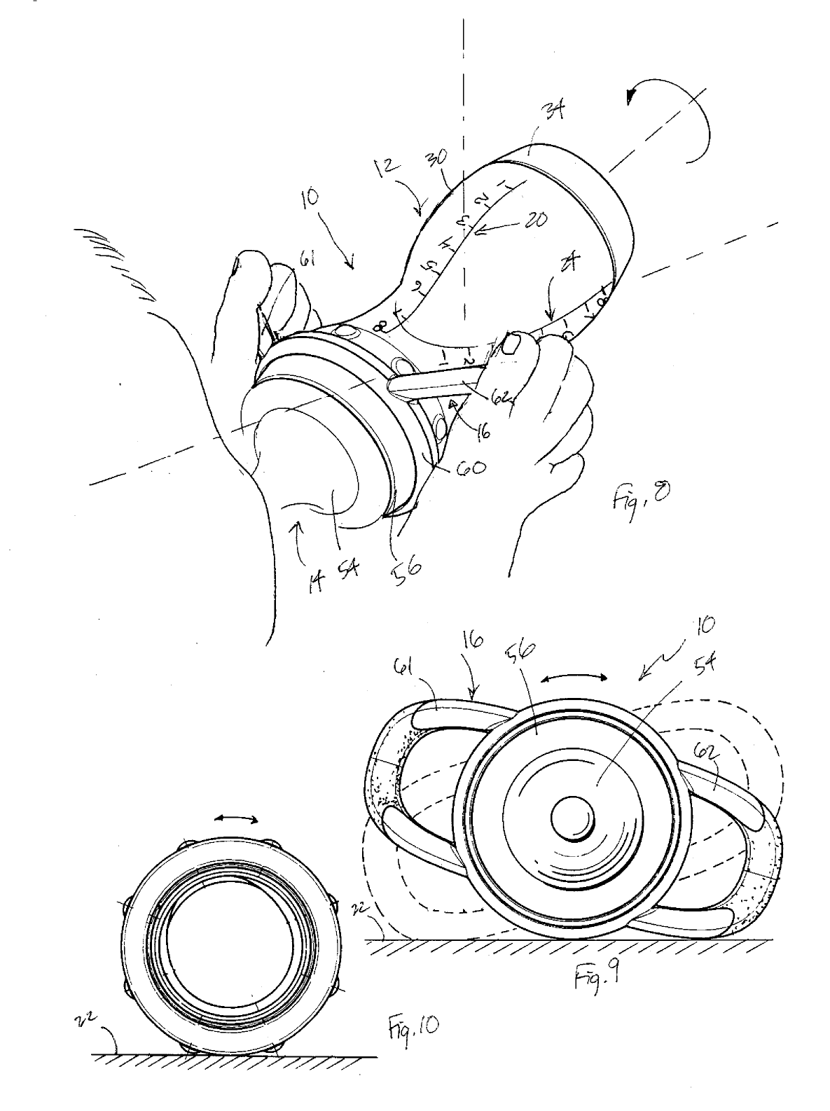

A liquid-dispensing bottle 10 includes a container 12, a liquid dispenser 14, a holder 16 interposed between container 12 and liquid dispenser 14, and a cap 18 mounted on liquid dispenser 14. A vertical volume measurement scale 20 is formed on container 12 to provide a visual indication of the volume of liquid 11 extant in container 12 when container 12 is placed in an upright orientation on an underlying surface 22 as suggested in FIG. 1. An inclined volume measurement scale 24 is formed on container 12 to provide a visual indication of the volume of liquid 11 extant in container 12 when container 12 is held (by an infant or caregiver) at about a predetermined angle 45 of about 45° with respect to a horizontal reference plane 26 as suggested in FIGS. 4 and 5. By using inclined volume measurement scale 24, a caregiver can monitor the volume of formula or other liquid consumed by the infant during feeding without removing the bottle from the mouth of the infant.

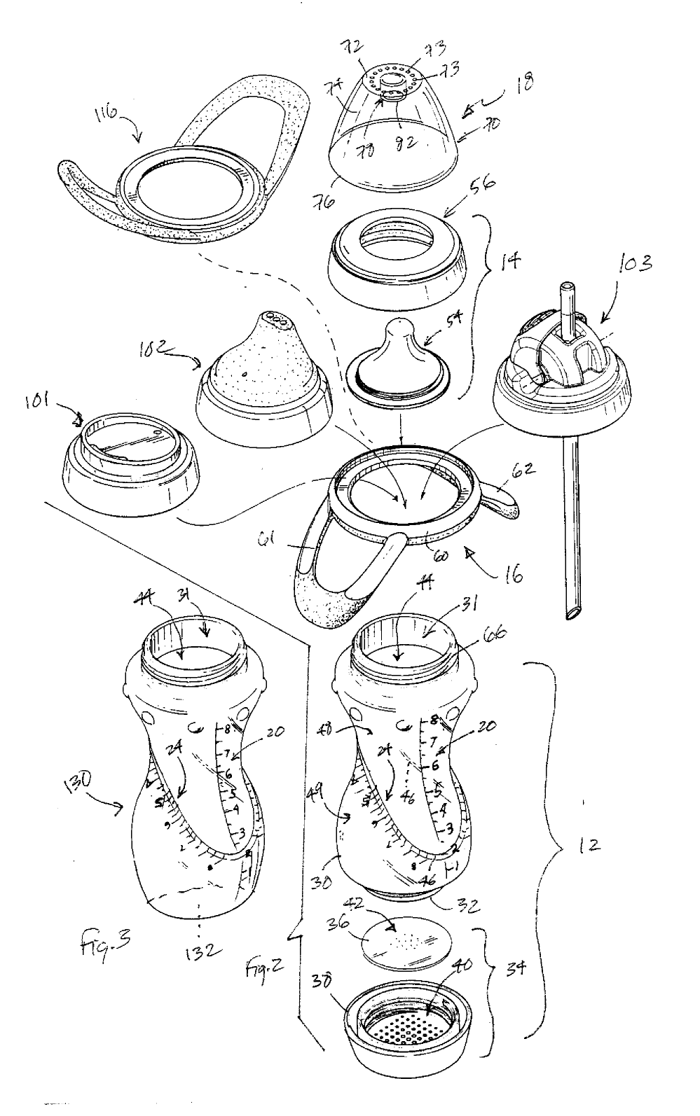

Container 12 includes a narrow-waisted sleeve 30 having an hour-glass shape and providing an open mouth 31 at an upper end thereof and a bottom opening 32 at a bottom end thereof as shown, for example, in FIG. 2. When bottle 10 is upright as shown in FIG. 2, vertical volume measurement scale is arranged to lie in a vertical orientation and the volume reference numbers are “smallest” (e.g., one ounce) near bottom opening 32 and “greatest” (e.g., eight ounce) near open mouth 31. In this same position, inclined volume measurement scale 24 is arranged to extend around curved portions of sleeve 30 in an inclined manner and the volume reference numbers are smallest near open mouth 31 and greatest near bottom opening 32.

As suggested in FIG. 4, inclined volume measurement scale 24 lies in a plane 100. When bottle 10 is oriented to cause plane 100 to lie in a vertical orientation, then the volume of liquid 11 remaining in bottle 10 will be shown accurately on inclined volume measurement scale 24. An approximate liquid volume is reported even when bottle 10 is inclined as shown in FIGS. 4 and 5 to cause plane 100 to lie in a nearly vertical orientation.

Container 12 further includes a bottom closure 34 comprising a valve 36 and a valve base 38. Valve base 38 is threaded to mate with sleeve 30 at the bottom end thereof to close bottom opening 32 and is formed to include an array 40 of vent apertures. Valve 36 is made of a pliable, sealing material and is formed to include an array 42 of vent apertures. Valve 36 is mounted in an interior region formed in valve base 38 for movement away from valve base 38 to a vented position opening the vent apertures in arrays 40 and 42 and toward valve base 38 to a sealed position closing the vent apertures in arrays 40 and 42. Valve 36 functions as a “one-way” diaphragm valve to allow ambient air to flow into an interior region 44 of sleeve 30 through aperture arrays 40, 42 as an infant is fed when bottle 10 is “inverted” or “inclined” as suggested in FIGS. 4 and 5 and to block flow of air and liquid through aperture arrays 40, 42 when bottle 10 is upright as shown in FIG. 1 and not in use. It is within the scope of this disclosure to form a narrow-waisted sleeve 130 provided with a monolithic bottom wall 132 as suggested in FIG. 3.

Narrow-waisted sleeve 30 of container 12 is formed to include an offset wall 46 having a somewhat teardrop-shaped profile as suggested in FIGS. 1, 2, and 6. Offset wall 46 is arranged to partition sleeve 30 to provide an upper portion 48 including open mouth 31 and a lower portion 49 including bottom mouth 32. Offset wall 46 establishes an inclined reference plane that is oriented to lie at an acute dihedral angle 53 of about 53° with respect to a horizontal reference plane as suggested in FIG. 6. Inclined volume measurement scale 24 is arranged to extend along a portion of offset wall 46 as shown in the figures. The width of offset wall 46 varies from a “maximum” at a point 51 closest to bottom opening 2 to a “minimum” at a point 52 closest to open mouth 31 as suggested in FIG. 1.

Liquid dispenser 14 includes a pliable nipple 54 and a nipple mount 56 as shown, for example, in FIGS. 1 and 2. A liquid-discharge aperture 58 is formed in nipple 52 as suggested in FIGS. 2, 6, and 7. Nipple mount 56 is configure to mate with sleeve 30 at the upper end thereof to hold nipple 54 in a fixed position closing open mouth 31 and regulating discharge of liquid 11 from container 12. Alternative liquid dispensers suitable for use with container 12 in the present disclosure include a lid 101, spout 102, and straw holder 103 as shown, for example, in FIG. 2.

Bottle holder 16 includes a mount ring 60 and a pair of grip handles 61, 62 coupled to mount ring 60 as shown, for example, in FIGS. 1, 2, and 6. Each of grip handles 61, 62 is arranged to lie at an angle 37 of about 37° with respect to a central axis 64 extending through bottle 10 as shown in FIG. 6. Mount ring 60 is sized and shaped to receive a threaded throat 66 providing open mouth 31 and to be trapped between sleeve 30 and nipple mount 56 as suggested in FIG. 6. In an illustrative embodiment, a soft material (stippled pattern) is overmolded onto portions of grip handles 61, 62 to provide easy-to-hold, non-slip, soft external grip portions on grip handles 61, 62, It is within the scope of this disclosure to invert bottle holder (see, e.g., 116 in FIG. 2) and mount inverted bottle holder 116 in the manner suggested in FIG. 2. Bottle 10 is easy for an infant to hold during feeding, in part, owing to use of a narrow-waisted sleeve 30 in container 12 along with splayed grip handles 61m 62 arranged to place the narrow waist portion of sleeve 30 therebetween.

Bottle cap 18 includes a shell 70 having a ceiling 72 and a conical side wall 74 extending from ceiling 72 and terminating at an annular rim 76 adapted to mate with liquid dispenser 14 as suggested in FIGS. 1, 2, and 6. Cap 18 also includes a drip container 78 located in an interior region 80 defined by shell 70 and arranged to depend from ceiling 72 as shown best in FIG. 6. Drip container 78 is a cylinder-shaped side wall terminating at an annular rim 82 sized to mate with a tip 84 of nipple 54 and surround liquid-discharge opening 58 formed in nipple tip 84 as shown in FIG. 6. When bottle 10 is inverted, as suggested in FIG. 7, any liquid droplets discharged through liquid-discharge opening 58 will pass into a liquid reservoir 86 formed in drip container 78. In the illustrated embodiment, ceiling 72 is formed to include one or more air vents 73 for venting air into interior region 80 of shell 70.

1. A liquid-dispensing bottle comprises
a container and
a liquid dispenser closing an open mouth of the container, the liquid dispenser being formed to include a liquid-discharge aperture configured to dispense liquid stored in the container to a child, wherein the container includes a vertical volume measurement scale arranged to provide a visual indication of a volume of liquid extant in the container when the container is not in use and is placed in an upright orientation on a table and wherein the container further includes an inclined volume measurement scale configured to provide means for providing a visual indication of a volume of liquid extant in the container when the container is maintained in an inclined position at about a predetermined angle with respect to a horizontal reference plane to provide the liquid dispenser to a child consuming liquid dispensed from the container so that a caregiver can monitor an amount of liquid being consumed by the child during feeding without interrupting that feeding to place the container in the upright position ion a table to determine the volume of liquid left in the container using the vertical volume measurement scale.
